(19) United States
(12) Patent Application Publication
(10) Pub. No.: US 2017/0070803 A1
(43) Pub. Date: Mar. 9, 2017

(54) Modular Earbud System and Method

(71) Applicant: Bharat Pulgam, Maple Grove, MN (US)

(72) Inventor: Bharat Pulgam, Maple Grove, MN (US)

(21) Appl. No.: 15/257,412

(22) Filed: Sep. 6, 2016

Related U.S. Application Data
(60) Provisional application No. 62/213,973, filed on Sep. 3, 2015.

(51) Int. Cl. H04R 1/10

(52) U.S. Cl. CPC H04R 1/1016; H04R 1/1033; H04R 2420/09

(57) ABSTRACT

A modular earbud system for listening to an audio device includes a bridge having a first earbud cord connector and a second earbud cord connector. The system also includes a first earbud and a second earbud. A first earbud cord has a distal end removably connected to the first earbud and a proximal end removably connected to the first earbud cord connector of the bridge. A second earbud cord has a distal end removably connect to the second earbud and a proximal end removably connected to the second earbud cord connector of the bridge. An audiojack cord has a distal end connected to the bridge and a proximal end adapted to connect to the audio device.

### CLAIM OF PRIORITY

This application claims the benefit of U.S. Provisional Patent Application No. 62/213,973, filed Sep. 3, 2015, the contents of which are hereby incorporated by reference.

### FIELD OF TIRE INVENTION

The present invention relates generally to personal audio systems and, in particular, to a modular earbud system and method for personal audio systems.

### BACKGROUND

An earbud is an audio device that a user wears in his or her ear. The earbud is configured so that it sits within the ear of the user. As a result, there is no need for a headband or strap to hold the earbud in position. Earbuds typically are part of a system or set where two earbuds are provided. A generally Y-shaped wire arrangement includes a pair of earbud wires where a distal end of each wire is attached to a corresponding earbud. The proximal ends of the earbud wires are typically joined at a junction. The distal end of a headphone or earbud jack wire runs from the junction and terminates at a proximal end that features a plug that engages the headphone or earbud jack of a smart phone or personal electronic audio device. Earbud sets are known to break very easily, usually due to the fraying of the earbud and jack wires. The remaining components of the set, however, are typically still functional. This forces the user to purchase a replacement set of earbuds when it would be much more cost-efficient to replace the wiring in order to repair the broken earbud set. Modularity would allow for this to happen by separating the earbud set into different parts or components. If one part or component breaks or malfunctions, only that part or component needs to be replaced, allowing the user to keep the remaining parts. As a result, the user is not required to buy an entirely new set and he or she only needs to pay for the broken or malfunctioning part. The user therefore saves money. Modularity would also allow for greater customization of the earbud set, which is a driving factor in customers choice of earbuds. By allowing for easy repair as well as quick and post purchase customization, a modular earbuds set or system improves a user's listening experience.

### DESCRIPTION OF THE DRAWINGS

FIG. 1 is a perspective view of a first embodiment of the earbud system of the present invention;

FIG. 2 is an exploded view showing assembly of the earbud system of FIG. 1;

FIGS. 3A and 3B are front and rear perspective views of an earbud in a second embodiment of the earbud system of the invention;

FIG. 4 is a perspective view of receptacle positioned on the distal end of an earbud cord in the second embodiment of the earbud system;

FIG. 5 is a front perspective view of a plug member of the second embodiment of the earbud system;

FIGS. 6A and 6B are front and rear perspective views of a bridge connector of the second embodiment of the earbud system;

FIGS. 7A-7C illustrate assembly of the second embodiment of the earbud system.

### DETAILED DESCRIPTION OF EMBODIMENTS

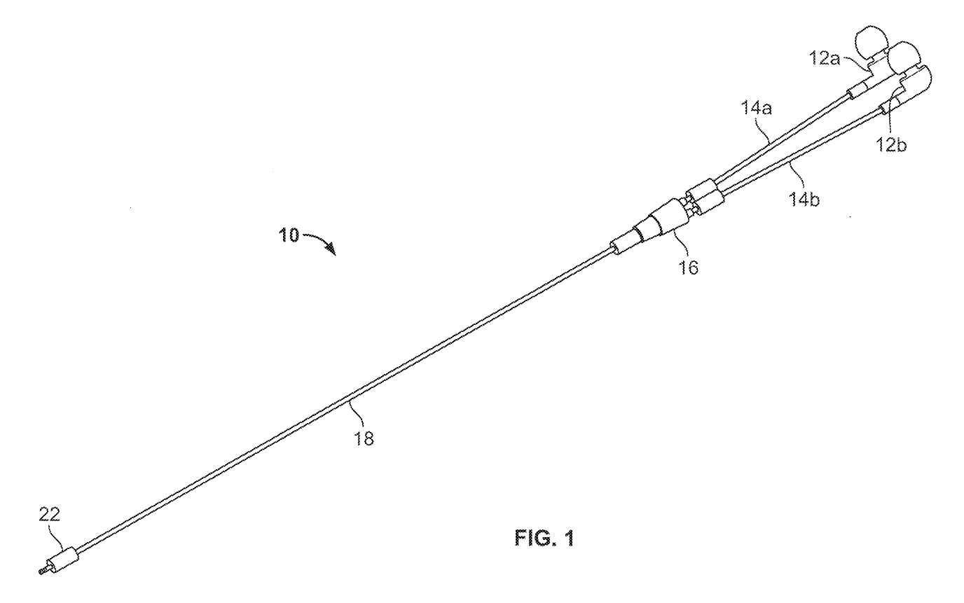

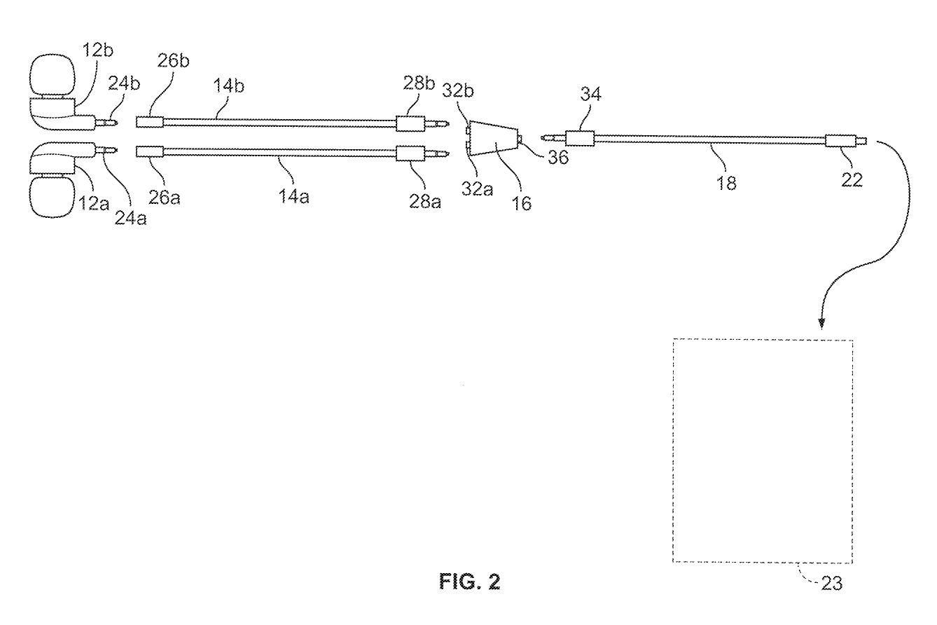

A first embodiment of the earbud set or system of the present invention is indicated in general at 10 in FIG. 1. As illustrated in FIG. 1, the earbud system features a pair of earbuds 112a and 12b that are placed one each in the ears of a user. A pair of earbud wires or cords 14a and 14b run from earbuds 12a and 12b, respectively, to a bridge (or bridge connector) 16. An audio jack wire or cord 18 runs from the bridge and terminates in an audio jack plug 22 that is adapted to be inserted into the jack of a smart phone or other personal electronic audio device (such as an IPHONE, IPOD, etc.), illustrated in phantom at 23 in FIG. 2.

As illustrated in FIG. 2, earbuds 12a and 12b are configured with plug members 24a and 24b, respectively. The distal end of earbud cords 14a and 14b are provided with receptacles 26a and 26b, that receive earbud plug members 24a and 24b, respectively, in a removable snap lock fashion. The proximal ends of the earbud cords 14a and 14b are provided with plug members 28a and 28b that removably engage corresponding earbud cord connectors such as ports 32a and 32b formed in the bridge 16 in a snap, twist, and lock fashion. The distal end of the audio jack cord 18 is similarly provided with a plug member 34 that removably engages a corresponding audio jack cord connector such as port 36 formed in the bridge connector 16 in a snap lock fashion. As a result, if any of the components (earbuds, earbud cords, bridge, audio jack cord or audio jack plug) breaks or malfunctions, the damaged component may simply be unplugged from neighboring components, removed from the system and replaced. The positioning of the plug members and receptacles/ports described above may be reversed in alternative embodiments. Furthermore, standard mini micro coax connectors (MMCX connectors) may be used in place of the illustrated plug members and receptacles/ports.

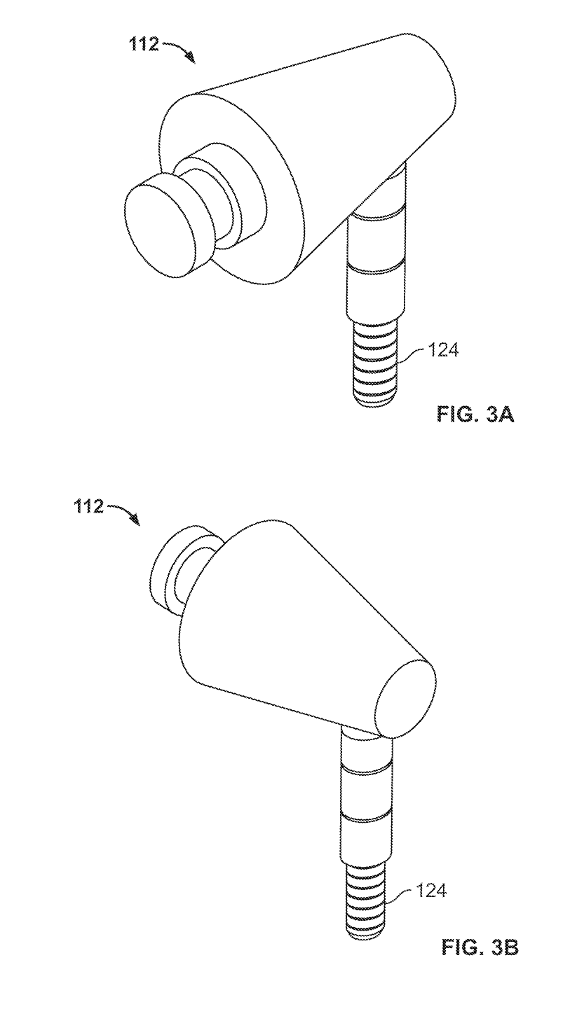

An earbud in a second embodiment of the earbud system of the invention is indicated in general at 112 in FIGS. 3A and 3B. As illustrated in FIGS. 3A and 3B, the earbud 112 is provided with a threaded plug member 124. Of course, as explained below, the second embodiment of the earbud set includes two such earbuds 112.

The distal end of an earbud cord 114 is shown in FIG. 4 and includes a receptacle 126. The receptacle features a threaded bore 127. The threaded bore is configured to receive the threaded plug member 124 of the earbud 112 of FIGS. 3A and 3B. More specifically, the plug member of the earbud screws into the bore of the receptacle to provide a locking connection that also provides a pleasant appearance. Of course the second embodiment of the earbud set includes two such earbud cords and receptacles (one for each earbud).

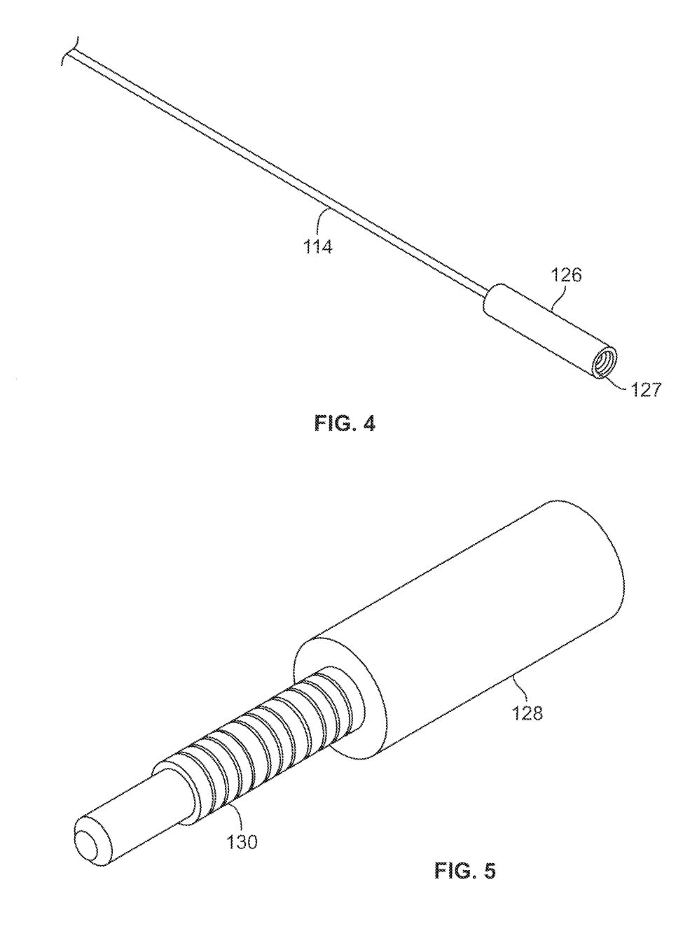

The proximal end of the earbud cord 114 of FIG. 4 is provided with the plug member 128 of FIG. 5. The plug member features a threaded portion 130. The distal end of the audio jack cord is also provided a plug member, such as the one illustrated at 128 in FIG. 5.

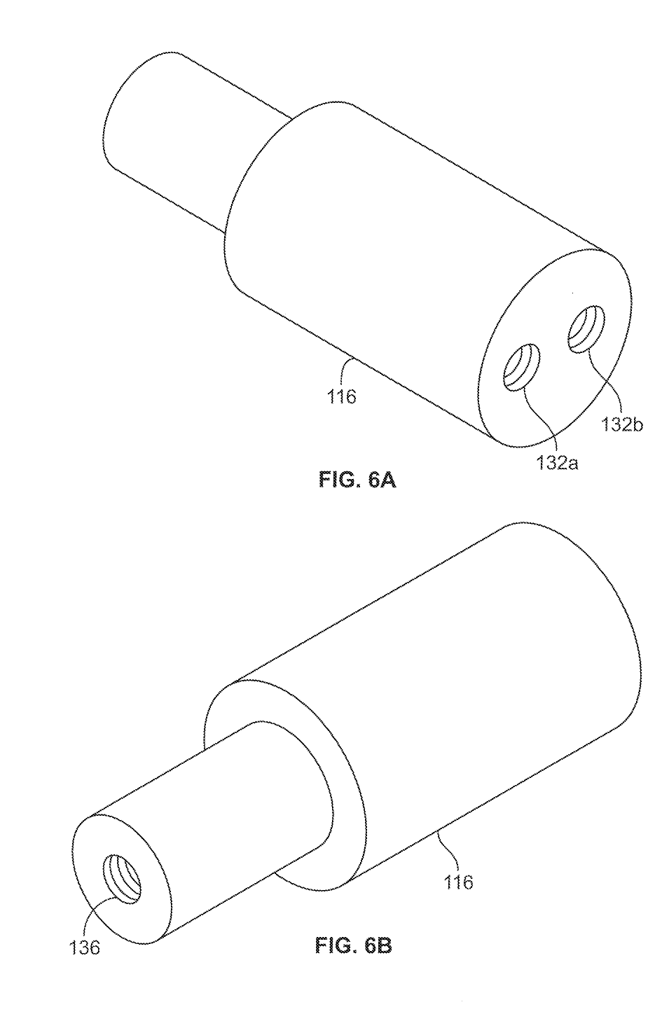

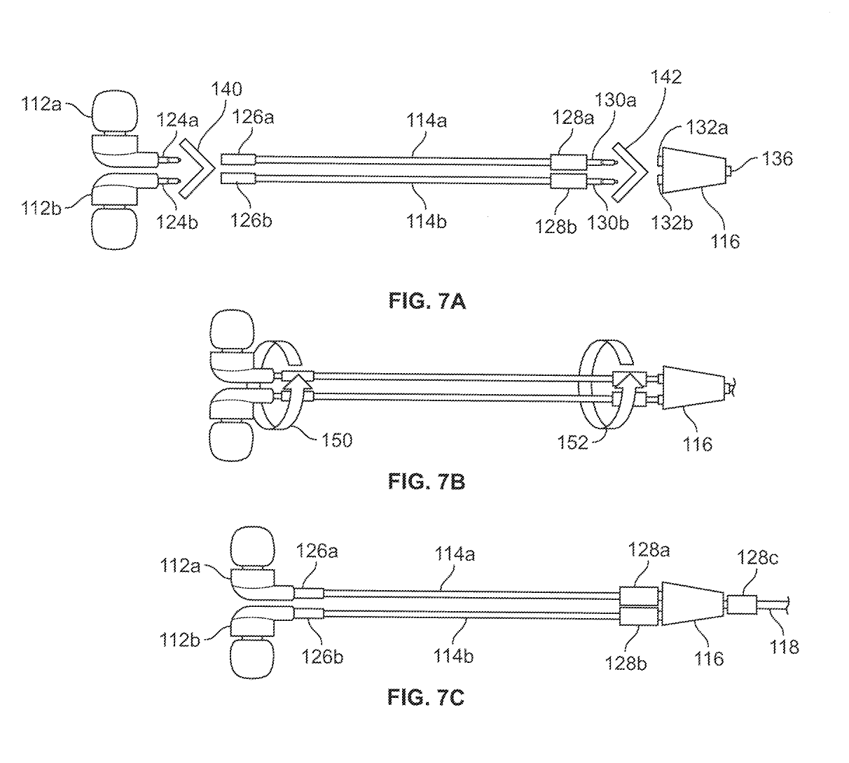

A bridge (or bridge connector) in the second embodiment of the earbud set is indicated at 116 in FIGS. 6A and 6B. As illustrated in FIG. 6A, the bridge 116 includes a pair of earbud cord connectors such as ports 132a and 132b that are threaded. As illustrated in FIG. 6B, the opposite side of the bridge connector is provided with a threaded audio jack cord connector such as port 136. Each port 132a, 132b and 136 of the bridge receives a corresponding threaded portion of a plug member (such as threaded portion 130 of plug member 128 of FIG. 5). As a result, the plug members may be screwed into the ports of the bridge 116 to removably attach the earbud cords (114 of FIG. 4) and audio jack cord (118 in FIG. 7C). As illustrated for the audio jack cord 18 of FIG. 2, the proximal end of audio jack cord 118 is provided with an audio jack plug (22 in FIG. 1) that is adapted to be inserted into the jack of a smart phone or other personal electronic audio device (such as an IPHONE, IPOD, etc.).

With reference to FIGS. 7A-7C, the assembly and disassembly of the second. embodiment of the earbud system will be described.

With reference to FIG. 7A and 7B, the threaded plug member 124a of earbud 112a is inserted into the threaded port of receptacle 126a, as illustrated by arrow 140 of FIG. 7A, and then turned, as illustrated by arrow 150 in FIG. 7B, so that the threads of the earbud plug member engage the threads of the receptacle port. The procedure is repeated using the threaded plug member 124b of earbud 112b and the threaded port of receptacle 126b. As a result, the earbuds 112a and 112b are secured to earbud cords 114a and 114b.

The threaded portion 130a of plug member 128a is then inserted into the earbud cord port 132a of the bridge connector 116, as illustrated by arrow 142 of FIG. 7A, and then turned, as illustrated by arrow 152 of FIG. 7B, so that the threads of the plug member threaded portion 130a engage the threads of the bridge connector earbud port 132a. The procedure is repeated using the plug member threaded portion 130b and bridge connector earbud port 132b. As a result, the earbuds 112a and 112b and the earbud cords 114a and 114b are secured to the bridge connector 116.

As illustrated in FIG. 7C, the audio jack cord 118 is provided with a plug member 128c that has a threaded portion that engages the audio jack cord port 136 (FIG. 7A) of the connector 116 in the manner described above for the earbud cords. As a result, the audio jack cord 118 is connected to the bridge connector 116.

The earbud system is now assembled and ready to plug into a smart phone or personal audio device, such as the one illustrated at 23 in FIG. 2, so that the listener may listen to the device through the earbuds.

The assembly steps described above with respect to FIGS. 7A-7C may be performed in any order.

If any of the components of the earbud system of FIGS. 3A through 7C becomes damaged, breaks or malfunctions, it may be removed from the set by reversing any of the steps described above for FIGS. 7A-7C, and then installing a replacement component.

In addition, the components of FIGS. 3A through 7C may be provided in a variety of colors, enabling the user to create his or her own customized earbud set featuring his or her choice of colors. For example, the earbuds 12a, 12b or 112a, 112b could be black, the earbud cords 14a, 14b or 114a, 114b could be red, the bridge connector 16 or 116 could be white, and the audio jack cord 18 or 118 could be red. Of course other colors and color combinations could be used.

Alternative connection arrangements known in the art could be substituted for the snap, twist, and lock mechanism or threaded connections described above.

While the preferred embodiments of the invention have been shown and described, it will be apparent to those skilled in the art that changes and modifications may be made therein without departing from the spirit of the invention, the scope of which is defined by the following claims.

What is claimed is:

1. A modular earbud system for listening to an audio device comprising:
a. a bridge having a first earbud cord connector, a second earbud cord connector and an audiojack cord connector,
b. a first earbud;
c. a second earbud;
d. a first earbud cord having a distal end removably connected to the first earbud and a proximal end removably connected to the first earbud cord connector of the bridge;
e. a second earbud cord having a distal end removably connected to the second earbud and a proximal end removably connected to the second earbud cord connector of the bridge; and
f. an audiojack cord having distal end removably connected to the audiojack cord connector and a proximal end adapted to connect to the audio device.

2. The modular earbud system of claim 1 wherein the first and second earbuds each include threaded plug members and the distal ends of the first and second earplug cords are provided with receptacles having threaded ports that are engaged by the threaded plug members of the first and second earbuds.

3. The modular earbud system of claim 2 wherein the first and second earbud cord connectors of the bridge are threaded ports and the proximal ends of the first and second earbud cords are provided with plug member having threaded portions that engage the threaded first and second earbud cord ports of the bridge.

4. The modular earbud system of claim 3 wherein the audio jack cord connector of the bridge is a threaded port and the distal end of the audio jack cord is provided with a plug.

5. The modular earbud system of claim 1 wherein the first and second earbud cord connectors of the bridge are threaded and the proximal ends of the first and second earbud cords are provided with plug members having threaded portions that engage the threaded first and second earbud cord ports of the bridge.

6. The modular earbud system of claim 1 wherein the audio jack cord connector of the bridge is threaded and the distal end of the audio jack cord is provided with a plug member having a threaded portion that engages the threaded audio jack cord port of the bridge connector.

7. The modular earbud system of claim 1 wherein the first and second earbuds each include receptacles having threaded ports and the distal ends of the first and second earplug cords are provided with threaded plug members that engage the threaded ports of the first and second earbuds.

8. The modular earbud system of claim 1 wherein the distal ends of the first and second earplug cords are provided with receptacles that are engaged by the first and second earbuds using snap, twist, and lock connections.

9. The modular earbud system of claim 8 wherein the first and second earbud cord connectors of the bridge are engaged by the proximal ends of the first and second earbud cords using snap, twist and lock connections.

10. The modular earbud system of claim 1 wherein the first and second earbud cord connectors of the bridge are engaged by the proximal ends of the first and second earbud cords using snap, twist and lock connections.

11. The modular earbud system of claim 10 wherein the audiojack connector of the bridge is engaged by the distal end of the audio jack cord using a snap, twist, and lock connection.

12. The modular earbud system of claim 1 wherein the audio jack connector of the bridge is engaged by the distal end of the audio jack cord using a snap, twist, and lock connection.

13. The modular earbud of claim 1 wherein the distal ends of the first and second earplug cords engage the first and second earbuds using mini micro coax connectors.

14. The modular earbud system of claim 13 wherein the first and second earbud cord connectors of the bridge are engaged by the proximal ends of the first and second earbud cords using mini micro coax connectors.

15. The modular earbud system of claim 14 wherein the audio jack connector of the bridge is engaged by the distal end of the audio jack cord using a mini micro coax connector.

16. The modular earbud system of claim 1 wherein the first and second earbud cord connectors of the bridge are engaged by the proximal ends of the first and second earbud cords using mini micro coax connectors.

17. The modular earbud system of claim 1 wherein the audiojack connector of the bridge is engaged by the distal end of the audio jack cord using a mini micro coax connector.

18. A modular earbud system for listening to an audio device comprising:
a. a bridge having a first earbud cord connector and a second earbud cord connector,
b. a first earbud;
c. a second earbud;
d. a first earbud cord having a distal end removably connected to the first earbud and a proximal end removably connected to the first earbud cord connector of the bridge; and
e. a second earbud cord having a distal end removably connect to the second earbud and a proximal end removably connected to the second earbud cord connector of the bridge; and
f. an audiojack cord having distal end connected to the bridge and a proximal end adapted to connect to the audio device.

19. The modular earbud system of claim 18 wherein the distal ends of the first and second earplug cords engage the first and second earbuds using mini micro coax connectors.

20. The modular earbud system of claim 19 wherein the first and second earbud cord connectors of the bridge are engaged by the proximal ends of the first and second earbud cords using mini micro coax connectors.
